(19) United States
(12) Patent Application Publication
(10) Pub. No.: US 2005/0048951 A1
(43) Pub. Date: Mar. 3, 2005

(54) Method and system for alternative access using mobile electronic devices

(76) Inventor: William H. Saito, Riverside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/648,150

(22) Filed: Aug. 25, 2003

(51) Int. Cl. H04M 1/66

(52) U.S. Cl. 455/411

(57) ABSTRACT

An identity authentication system that controls access to devices information and areas only to authorized individuals. The system includes one or more processors that have a communication interface such that the processor can transmit signals to personal communication devices carried by individuals, such as cellular telephones, PDAs, pagers, and the like. The individual, to gain access to a particular secure component, area or information, is then prompted to provide PIN numbers or access codes via their personal communication device.

### RELATED APPLICATIONS

This application is related to U.S. Application No. ______ (Atty Docket No. IOSOFTW.003A), entitled “METHOD AND SYSTEM FOR SECURE AUTHENTICATION USING MOBILE ELECTRONIC DEVICES”, which is hereby incorporated in its entirety herein.

### BACKGROUND OF THE INVENTION

1. Field of the Invention

The present invention relates to security systems and, in particular, concerns a system for authenticating the identity of an individual requesting access to a secure component.

2. Description of the Related Art

In modern businesses, controlling access to sensitive information or valuable assets is of substantial concern. Computer networks often include proprietary information or private information about finances, employees or trade secrets that cause companies to attempt to restrict access to only those authorized to make use of this information. Similarly, many businesses or government institutions have particular areas of their facilities for which access is limited to a small number of authorized personnel. Examples of such locations include vaults containing valuable or sensitive records or rooms that contain sensitive data storage equipment.

One primary concern in maintaining the security of sensitive information and areas is the ability to ensure that only authorized users are entering the particular location. Generally, a limited number of people are identified as having access to the sensitive information or area and a variety of techniques are then used to ascertain whether the person seeking access to the information or area is actually authorized to do so. Determining whether an individual is authorized to access a particular area or information can be accomplished using a variety of different mechanisms which attempt to verify the identity of the individual seeking access. The amount of information that is gathered from the individual seeking access is generally proportionate to the level of security needed to protect the secure area or information.

FIG. 1 schematically illustrates the various types of identity authentication systems currently in use. The first type of authentication identified is Type I authentication in which the individual is asked to provide information about what they know that identifies the individual before access is granted. Logging on to a computer and accessing an ATM machine are classic examples of Type I information in that the individual must then enter an access code, such as a password or Personal Identification Number (PIN) which, presumably, only that individual knows. This information is then verified by a monitoring system to verify that the PIN number or password is correct prior to access being allowed. While Type I authentication is quite common for simpler devices, access codes can be stolen or can be ascertained by unauthorized individuals. As a consequence, in many circumstances, Type I authentication is viewed as not sufficient to provide adequate security.

A second type of authentication, referred to as Type II authentication in FIG. 1, is predicated on the individual seeking access having a uniquely coded item which is readable by a security system. The uniquely coded item may include such things as passcards, tokens, keys and the like. Presumably, only an individual having authorization to access a particular secure component would have in their possession the uniquely coded security item. Often, Type I and Type II authentication schemes are combined such that access is only allowed to individuals who have both a uniquely coded security item and knowledge of a password or PIN number. The advantage of Type II authentication is that the number of people having a uniquely coded key or token can be better controlled. However, keys and tokens can also be stolen.

Moreover, requiring individuals to carry additional items to obtain access can be problematic. Specifically, individuals may forget their Type II security item thereby not allowing them access without administrative intervention. This is a significant drawback of Type II authentication systems as it requires a person to have in their possession an item which only has one particular use, namely allowing access. As such, these types of devices are often forgotten. Further, security systems that incorporate Type II devices generally require additional hardware to implement. Readers capable of reading the encoded information on the card, token, etc. typically have to be installed at locations where the individuals will seek access. If these types of devices are used to control access to many different devices by many different individuals, the cost of such a Type II security system can be substantial as installation of many readers may be necessary.

Another type of identity authentication is Type III security authentication which is generally referred to as biometric authentication. In this type of authentication, a physical characteristic of an individual, such as their voice print, their fingerprint or their retinal pattern, is scanned and compared to prerecorded information relating to this biometric information. Biometric evaluation of a person is perhaps one of the most secure ways of ascertaining or authenticating the identity of a person seeking access, however, biometric evaluation is often expensive in that it requires more sophisticated sensors to capture the biometric feature of the individual. Moreover, many current biometric sensors are also difficult for individuals to use which further results in individuals being less inclined to implement biometric-based security devices.

FIG. 1 also illustrates two other types of identity authentication models, including identity authentication models based upon what an individual does (Type IV) and also identity models based on the location of an individual when seeking access. Identity authentication based upon the characteristics of an individual can be as simple as comparing a digitally captured signature signed by the individual to a prerecorded signature. Alternatively, characteristics, such as key strike pattern, voice recognition and the like, may also be used in certain circumstances to verify information.

One difficulty with all of these identity authentication models is that it is difficult to find a balance between cost and adequate security. The less expensive types of identity authentication, i.e., passwords, PIN numbers and the like, can be more easily compromised. The use of identity card keys and tokens also suffer from the drawback of being lost, forgotten or stolen, thereby further compromising security. In contrast, the more secure systems, such as biometric evaluation, are, again, very difficult to use and expensive to implement.

It will be appreciated that there is a continuing need for an identity authentication system that is more secure than simple passwords and PIN numbers but is easier to use and cheaper to implement than more sophisticated biometric-type identity authentication systems. To this end, there is a need for identity authentication using a system that does not require the addition of expensive components and is less prone to the difficulties associated with lost, forgotten or stolen devices.

### SUMMARY OF THE INVENTION

The aforementioned needs are satisfied by the identity authentication system of the present invention. In one particular implementation, the identity authentication, in response to an attempt by an individual to access a secure device, information or area, communicates with the individual via a communication device possessed by the individual. The communication can comprise a plurality of different formats including a prompt requesting a signal to enter an access code into the communication device for transmission back to the system or a signal to enter an access code into an input interface associated with the secure component. The communication device can comprise cellular telephones, pagers and PDAs. It will, however, be appreciated that any of a number of communication devices that have a communication capability can be used to implement the identity authentication system without departing from the present invention.

It will be further appreciated that one advantage of the identity authentication system that makes use of personal communication devices carried by the individual and requires the individual to input an access code is that two levels of security, e.g., what the individual knows (Type I) and what the individual has (Type II), can be implemented as the individual must have the communication device and also be able to enter the appropriate information prior to obtaining access. The problems associated with the use of tokens, keys or identity cards is reduced in that the communication device is generally a device that many individuals carry with them as a matter of course.

Moreover, implementing a system whereby the security system contacts a cellular telephone or similar device does not require the same expensive investment in infrastructure that more sophisticated biometric-based systems require. In fact, the identity authentication system can even be more readily implemented than most Type II security systems as a central communications interface, such as a modem, can be connected to the security system which is then programmed to send and receive signals with the individual's personal communications device. Hence, the need to install multiple reader devices adjacent multiple secure devices to read tokens, cards, etc. is reduced thereby reducing the overall cost of the system.

Further, by making use of an individual's personal communications device, supplemental security procedures can be implemented in a more cost effective manner. For example, if a Type II security procedure is being implemented, the individual seeking access to a secured component must have in their possession an access device, e.g., card or token. On occasion, individuals forget their access device. In these circumstances, security personnel for the system must make one time arrangements to allow the individual access to the secured component. This may take the form of the security personnel bypassing the access requirement, or providing the individual access using the security person's own access card or token. This can represent a significant administrative burden for large systems and can also compromise the security of the system.

To address this issue, in another aspect of the invention, the system is configured such that when a person has forgotten their access device, the system utilizes the individual's personal communications device to provide an access code in lieu of the token or key. In one implementation, the system, via the secured component, provides an access code that can then be sent to an access controller of the system via the individual's personal communications device. In one specific implementation, the system identifies the individual's personal communication's device and only allows access to the secured component when it receives the correct access code via the personal communications device that is known to be registered to the individual.

In another implementation, the security system sends the access code to the personal communications device known to be registered to the individual seeking access and the individual then enters the access code via an input of the secured component. In either of these implementations, the individual's personal communications device can be used as a substitute for a token or access card without requiring significant intervention by security personnel thereby resulting in a more cost efficient security system. Moreover, since the individual is using their own personal communications device, some degree of Type II security is maintained.

These and other objects and advantages of the present invention will become more apparent from the following description taken in conjunction with the accompanying drawings.

### BRIEF DESCRIPTION OF THE DRAWINGS

FIG. 1 is a block diagram illustrating various types of identity authentication;

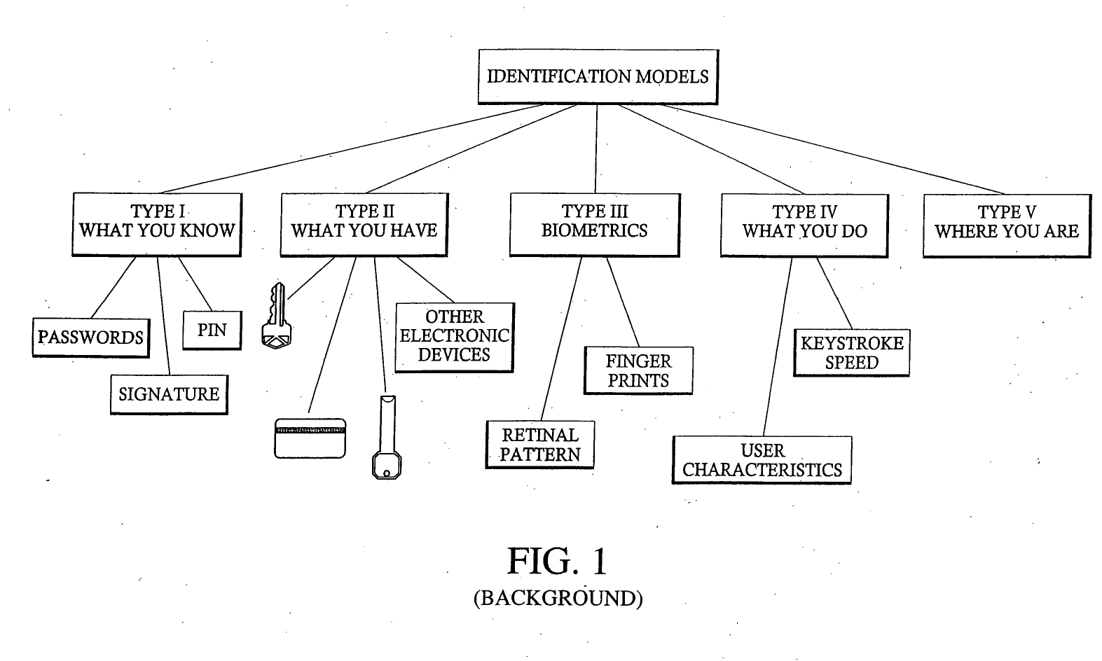

FIG. 2 is a block diagram of one exemplary embodiment of an identity authentication system of the present invention;

FIG. 3A is an exemplary data structure of user security attributes which forms a portion of the identity authentication system of FIG. 2;

FIG. 3B is an exemplary data structure of device access attributes which also forms a portion of the identity authentication system of FIG. 2;

FIG. 3C is an exemplary supplemental command reference table which forms a portion of the identity authentication system of FIG. 2;

FIG. 4 is an exemplary flow chart illustrating the operation of the identity authentication system of FIG. 2 as it determines whether to allow an individual access to a selected device, information, or area;

FIG. 5A is an exemplary flow chart of a first security protocol which can form a portion of a flow chart of FIG. 4;

FIG. 5B is an exemplary flow chart of a second security protocol which can form a portion of the flow chart of FIG. 4;

FIG. 5C is an exemplary flow chart of a third security protocol which can form a portion of the flow chart of FIG. 4;

FIG. 6 is an exemplary flow chart illustrating the operation of the identity authentication system of FIG. 2 as it implements a supplementary command in response to an input of an individual.

FIG. 7A is an exemplary flow chart illustrating the operation of the identity authentication system of FIG. 2 as it implements a first alternative access protocol for individuals seeking access to a secured component protected by a Type II security protocol; and

FIG. 7B is an exemplary flow chart illustrating the operation of the identity authentication system of FIG. 2 as it implements a second alternative access protocol for individuals seeking access to a secured component protected by a Type II security protocol.

### DETAILED DESCRIPTION OF THE PREFERRED EMBODIMENT

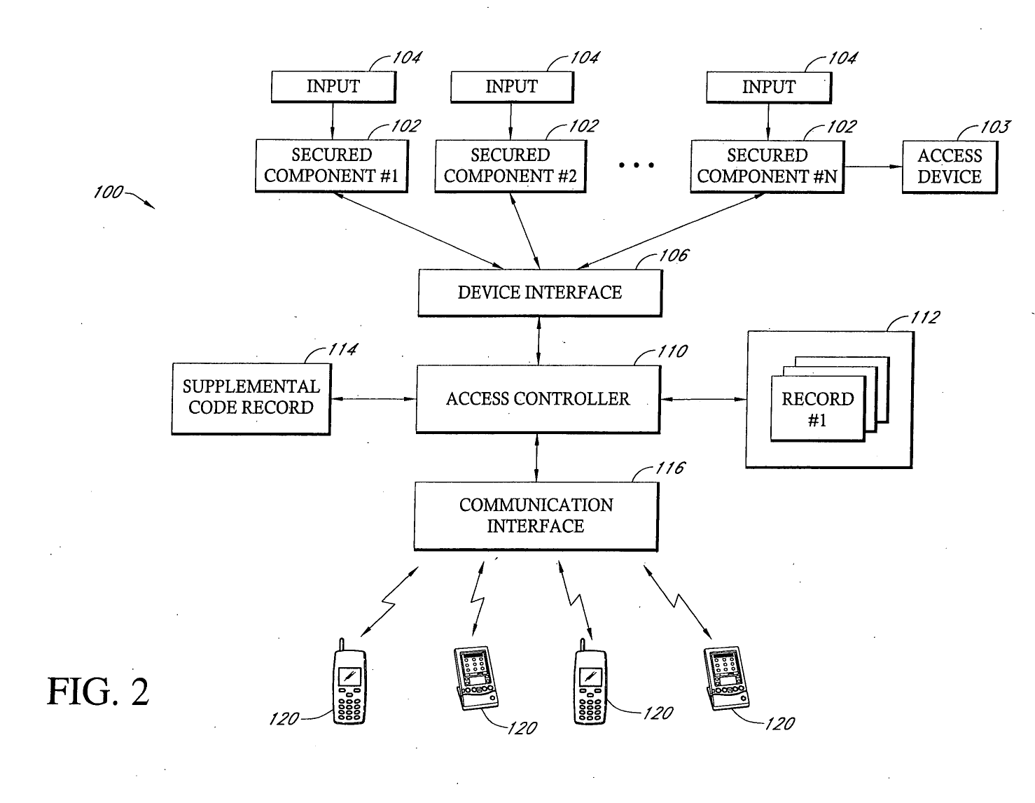

Reference will now be made to the drawings wherein like numerals refer to like parts throughout. FIG. 2 is a block diagram which illustrates one exemplary embodiment of an identity authentication system 100 of the present invention. It will be appreciated that the block diagram of FIG. 2 is simply an example of one logical organization of the identity authentication system 100 and that any of a number of different organizations of a system can be implemented without departing from the spirit of the present invention. Referring to FIG. 2, the system 100 includes a plurality of secure components 102 that can comprise any of a number of different devices in which access to a device itself, an area or information accessible through a device is limited to particular individuals. Common examples would be networked computers or terminals that have access to secure information, such as financial information, intelligence information, and the like. Another example of a secure component 102 would be an entry device into a particular area, such as a vault or an area containing sensitive information. Yet another implementation of a secure component 102 would be a computer which is part of a network that allows general access to some portions of the network but allows access to other portions of the network only to selected individuals. In general, the secure components 102 have an associated input 104 whereby the individual seeking access to the secure components can enter identification information. This identification information is then subsequently evaluated by the identity authentication system 100 in the manner that will be described in greater detail below.

As is illustrated in FIG. 2, communication between each of the secure components 102 and an access controller 110 occurs via a device interface 106. The device interface 106 can be any of a number of different interfaces that interconnect at least one secure component 102 with the access controller 110. Examples can include local area or wide area networks, as well as Internet-type networks. As will be described in greater detail below, the access controller 110 receives signals from the secure components 102 and implements a process whereby the identity of the individual seeking access to a secure component 102 is authenticated. The access controller 110 is graphically illustrated as a single processor, however, it will be appreciated that the implementation of the access controller 110 can be accomplished in any of a number of ways without departing from the spirit of the present invention.

As is also illustrated in FIG. 2, the access controller 110 also has access to a plurality of records 112 that allows the access controller 110 to determine whether to allow access to a particular secure component by a particular individual. The contents of the particular record and the process by which the records are used to authenticate the identity of an individual seeking access is described in greater detail below. As is also illustrated in FIG. 2, the access controller 110 can also access a supplemental code record 114 which allows the access controller 110 to enable one or more of the secure components 102 to implement an activity other than allowing access to the secure component.

As is also shown in FIG. 2, the access controller 110 also has a communications interface 116 that allows the access controller 110 to communicate with a plurality of individual communication devices 120 that are carried by individuals whose identity is to be authenticated by the controller 110. The communications interface 116 can comprise any of a number of communication devices that allow a processor to send text or voice messages to the individual communication devices 120 and can include such things as modems, network cards, wireless transmitters, etc.

As discussed above, the communication devices can include cellular telephones, pagers, PDAs, etc. having an address or telephone number that is unique for each device and individual. The records 112 associate each of the communication devices 120 with a particular individual such that when the individual is accessing one of the secure components 102 the access controller 110 is notified of this via the device interface 106 and can thereby send signals to the communication device 120 associated with the individual based upon the information stored in the records 112. In this manner, the authentication of the identity of a person seeking access to one of the secure components 102 can be implemented by sending signals to the communications device 120 and evaluating the response from the individual either via the communication device 120 or via the input 104 of the secure component 102.

Hence, identity authentication can therefore advantageously require an individual to know a particular access code such as a PIN number, password, etc. and also to have in their possession the communication device 120 to receive and/or send a communication to the access controller 110. Since many individuals already carry personal electronic communication devices, this implementation of the system 100 will not require individuals to carry additional tokens, key cards, etc. Moreover, the communication devices 120 are already assigned to individuals such that the system 100 can be implemented by associating in a record the communications path, e.g., how to send a signal to the communications device, for each individual and establishing a security protocol by which identity authentication is to be achieved. The communications interface 116 can be the only required hardware needed to implement this embodiment of the system thereby reducing the cost of implementing the identity authentication system described herein.

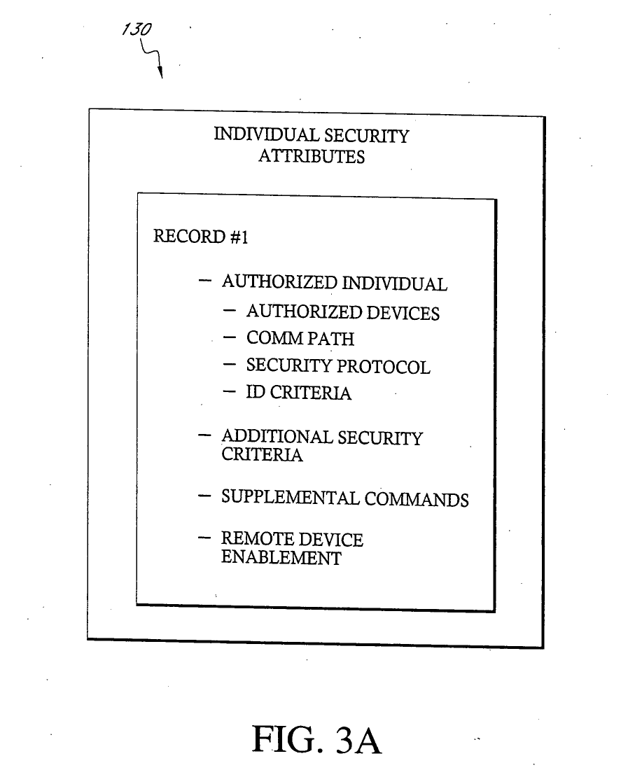

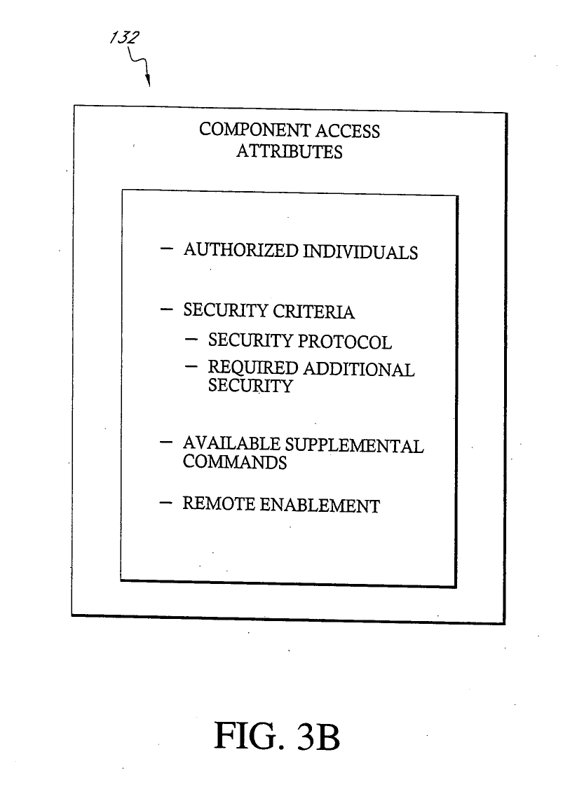

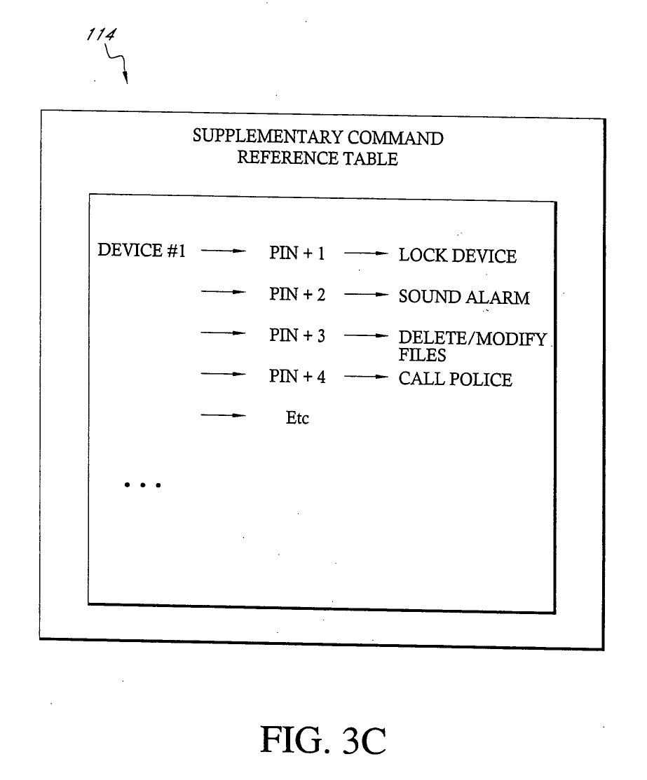

FIGS. 3A-3C are graphical representations of the type of information in the records 112 that is accessible by the access controller 110. These illustrations show the type of information that the access controller 110 can access and, it will be appreciated, that this information can be stored in any of a number of different data structures including relational databases, etc. Referring initially to FIG. 3A, individual security attributes 130 can be stored in the records 112 which define information relating to particular individuals. As is illustrated in FIG. 3A, this information can include an identification of the authorized individual and an identification of the devices, information, or areas that the individual is allowed to access. Preferably, this information is stored in a manner which can be updated and changed as the authorization level of a particular individual changes over time. The individual security attributes can also include a communications path by which the controller 110 can contact the individual. In one particular implementation, the communications path comprises a telephone number corresponding to the individual's cellular telephone. This information can be accessed by the access controller 110 when sending an identity authentication signal to the communication device 120 corresponding to this particular individual.

The individual security attributes 130 also preferably includes some type of security protocol which defines the manner in which the access controller 110 performs identity authentication for this particular individual. As will be described in greater detail below, there are a number of different security protocols that may be implemented by the access controller 110 to authenticate the identity of the individual. There will also be an ID criteria, such as an access code, e.g., a password or PIN number or the like, that is associated with this particular individual such that the individual will enter the ID criteria either via the communication device 120 or via the input 104 of the secure component 102 such that the access controller can determine whether to allow access in the manner described below.

Other user security attributes can include additional security criteria, such as additional passwords that will allow access to additional functionality of a particular secure component, and a link to supplemental commands that can be entered via the communication device 120 which will instruct the access controller 110 to implement a particular supplemental command.

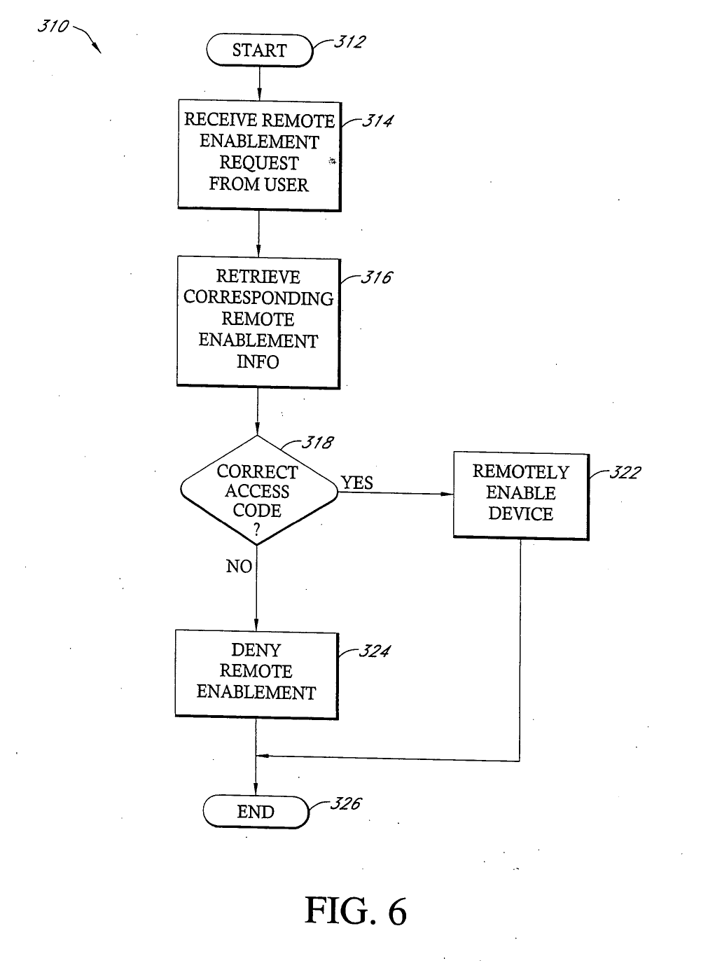

Further, there is also an attribute for a particular individual as to whether they are authorized to use their communication device 120 to enable one of the secure components 102 via the access controller 110. As will be described in greater detail below in connection with FIG. 6, the access controller 110 can be programmed such that when an individual contacts the access controller 110 via their communication device 120 and sends a coded signal to the access controller 110, the access controller 110 can then be programmed to enable or initiate a particular functionality of one of the secure components 102. One example would be a particular individual contacting the access controller 110 using their cellular telephone and entering a particular identification code which then induces the access controller 110 to send a signal via the device interface 106 to a particular personal computer that comprises a secure component 102 such that the computer is turned on and enabled remotely by the individual. This particular functionality can presently be implemented using wake-on-LAN functionality that is built into many personal computers currently available.

FIG. 3B illustrates component access attributes 132 that relate to particular secure components 102. These device access attributes 132 can include such things as which individuals are authorized to access a particular component 102 and the security criteria for allowing access to particular individuals. The security criteria can include the protocol by which identity authentication is conducted and also whether there are any required additional security steps that must be undertaken to allow access to a particular secure component 102. Further, component access attributes 132 may also include whether supplemental commands, such as those described below in connection with FIG. 3C, are available for a particular secure component 102 and also whether a particular secure component 102 is available for remote enablement. Again, FIGS. 3A and 3B are simply graphical representations of the type of information that is stored in the records 112 relating to particular components and to particular individuals. These attributes may be stored in two separate databases or, alternatively, in a single interrelated database in a manner known in the art.

FIG. 3C illustrates the types of commands that are contained within the supplemental code record 114. As will be described in greater detail below, the access controller 110 may be preprogrammed to implement particular commands that are received via the communication device 120. For example, if an individual provides an appropriate access code, such as a PIN number, to the access controller 110 that would allow for access to a particular secure component 102 and then adds an additional digit or code, particular functionality can be implemented by the controller. In the example of FIG. 3C, calling on a cellular telephone and entering an access code plus the number 1, will result in the access controller 110 locking the secure component 102 for which the individual is seeking access. This particular feature is helpful in circumstances where the individual may be coerced or forced into gaining access to the particular secure component in question.

As is further illustrated in FIG. 3C, additional digits after the access code can result in different functionality being implemented by the access controller 110. For example, inputting the number 2 may result in an alarm being sounded, inputting the number 3 may result in files being deleted or modified and inputting the number 4 may result in the police being called in response to the person accessing a particular device.

It will be appreciated that the secure component 102 can be structured such that correct input of the access code by the individual allows partial or limited access to the secure component 102 but by adding a single digit following the access code additional security steps can be taken without the person who may be coercing an individual to gain access to the secure component 102 being made aware of the fact that the individual is communicating with the access controller 110 to implement additional security steps. Moreover, while the supplemental commands listed in FIG. 3C generally relate to additional security steps, the inputting of additional numbers following the individual successfully entering a particular ID criteria, e.g., PIN number, to access a secure component 102 can result in the access controller 110 implementing any of a number of different functions.

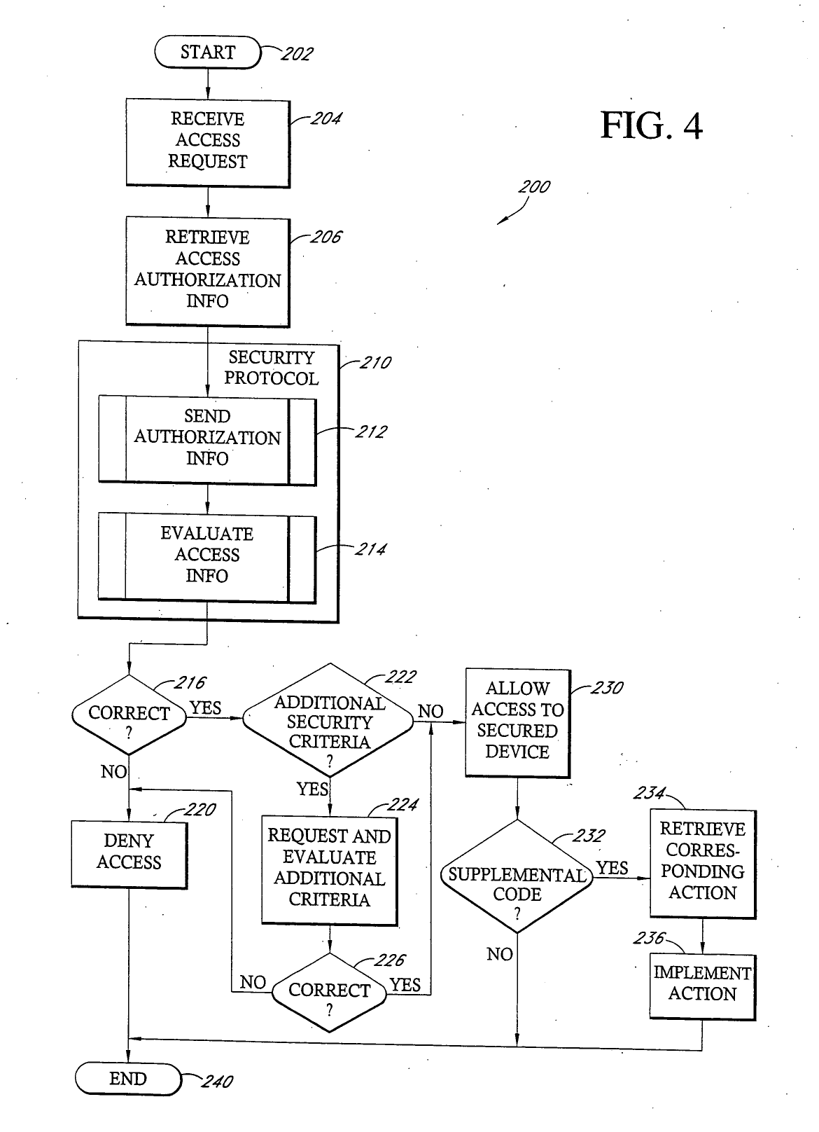

FIG. 4 is a flow chart of an identity authentication process 200 implemented by the controller 110. The flow chart of FIG. 4 is, again, simply an exemplary illustration of the basic process steps the controller 110 or its equivalent would take to perform the identity authentication to allow an individual access to a particular secure component 102. In this particular implementation, from a start state 202, the controller 110 receives an access request, in state 204. An access request can occur in a variety of different manners, including having the individual manipulate an input 104 of the secure component 102 which results in the secure component 102 sending a signal via the device interface 106 to the access controller 110 indicating that a particular individual is attempting to gain access. Alternatively, the access controller 110 may receive an access request, in state 204, from the communication device 120 as a result of the individual sending an appropriate signal. In either circumstance, the access request identifies the individual seeking access to the secure component 102. In one example, the individual enters a login ID via the input device 104 associated with the secure component 102 which identifies the individual. In another example, the controller 110 recognizes the telephone number of individual calling via the communications interface 116.

Once the access request has been received, the access controller 110 then retrieves the access authorization information, in state 206, for the individual. The controller 110 retrieves information from the records 112 which indicate whether the individual is authorized to access the secure component 102 and the security protocol that is to be implemented to perform the identity authentication for the individual from the individual security attributes 130 or component attributes 132 of the records 112. Once the appropriate information has been received, the controller 110 then implements the security protocol, in state 210, to authenticate the identity of a particular individual. The particular security protocol 210 can, of course, vary depending on the individual or depending upon the secure component 102.

In general, all of the security protocols 210, in this particular implementation, require communication with the individual's communication device 120 and further require input signals via the input 104 of the secure component 102. The communication generally includes sending authorization information, in state 212, which can comprise a prompt which asks the individual to enter in an access code via their communication device 120 or via the input 104 of the secure component 102. Subsequently, the access code, e.g., password or PIN number, that is entered by the individual in response to receiving the authorization information, in state 212, is then evaluated by the access controller 110, in state 214, and the controller 110 then determines, in decision state 216, whether the access information provided by the individual is correct.

As an example, an individual seeking access to a particular room that has a secure component 102 comprising a networked combination lock, may initially input a user ID via the input 104 of the lock to signal the controller 110 that the individual is seeking access to the locked area. The controller 110 may then retrieve information from the records 112 to thereby ascertain the communication path, the security protocol and the ID criteria for the particular individual. Subsequently, the controller 110 implements, in function 210, a security protocol whereby a prompt requesting a particular access code, e.g., PIN number, from the individual is sent via the communications interface 116 to the individual's cellular telephone. In this example, the controller 110 dials the individual's telephone via a modem and then sends a text message prompt when the individual answers. The individual then responds by typing in a PIN number or password using the telephone's keypad and transmits the PIN number or password to the controller 110. The access controller 110 then evaluates the PIN number, in state 214, by comparing the PIN number to the ID criteria previously recorded for the particular individual. If the information is correct, then the initial security criteria is satisfied for this particular individual.

As is illustrated in FIG. 4, the controller 110 can then determine, in decision state 222, whether any additional security criteria is listed either for this particular secure component 102 in the component access attributes 132 or for the particular individual in the individual security attributes 130. In some circumstances, access to a particular secure component 102 may be a multi-step process such as, for example, the individual having to input multiple correct access codes via their communication device 120.

Another additional security criteria could be the location of the individual when the individual is communicating to the controller 110 using their communication device. In cellular telephony, the geographic location of the caller can be generally identified by the cell site that is handling the call. In this implementation, this information can be queried by the controller 110 via the interface 116. The additional security criteria can then be whether the individual is calling from a pre-selected location, e.g., a location proximate the secure component 102. In this way, three levels of security can be easily achieved by the system 100: 1) the individual must have in their possession their communication device, 2) the individual must know the correct access code, and 3) the individual must enter the access code while being in a particular location. In some implementations, the communication device 120 could have wireless capability which could therefore require the to individual to receive the signal wirelessly, and thus be within an even smaller distance of the secure component 102.

If the access controller 110 determines, in decision state 222, that additional security criteria are required, the controller then requests and evaluates the additional criteria, in state 224. If the additional criteria is determined by the access controller 110 to be correct, in decision state 226, then access to the secure component is allowed in state 230. Typically, allowing access, in state 230, to a secure component 102 entails sending an appropriate signal via the device interface 106 to the secure component 102 such that the functionality of the secure component 102 is enabled, e.g., an individual is allowed access to a particular computer program in a network computer or computer terminal or a lock to a particular area is unlocked.

If the controller 110 determines, in decision state 216 or in decision state 226, that the security criteria or the additional security criteria is not satisfied, the controller 110 then denies access in state 220. This is accomplished by either sending an appropriate disable signal via the device interface 106 to the secure component 102 in question, or, alternatively access is denied by simply not sending an enable signal to the secure component 102. It will be appreciated that the manner in which access or denial of access signals is sent to the secure component in question can, of course, vary greatly depending upon the implementation without departing from the spirit of the present invention.

As is further illustrated in FIG. 4 and was described above in connection with FIG. 3C, the controller 110 also determines, in decision state 232, whether additional supplemental codes have been sent by the individual via their communication device 120. An initial part of this particular determination is whether the secure component 102 and the individual are authorized to implement supplemental commands. If the access controller 110 determines that it has received a supplemental command from the individual and that, according to the individual attributes 130 and the device attributes 132, the security component 102 and the individual support the supplemental command, the controller 110 then retrieves the corresponding action, in state 234, from the supplemental code record 114. Subsequently, the controller 110 then implements the corresponding action in state 236. While the flowchart of FIG. 4 illustrates that the supplemental code is evaluated and implemented subsequent to allowing access to the secure component, it will be appreciated that this evaluation can also occur simultaneously with the determination of whether to allow access in the first place to the secure component.

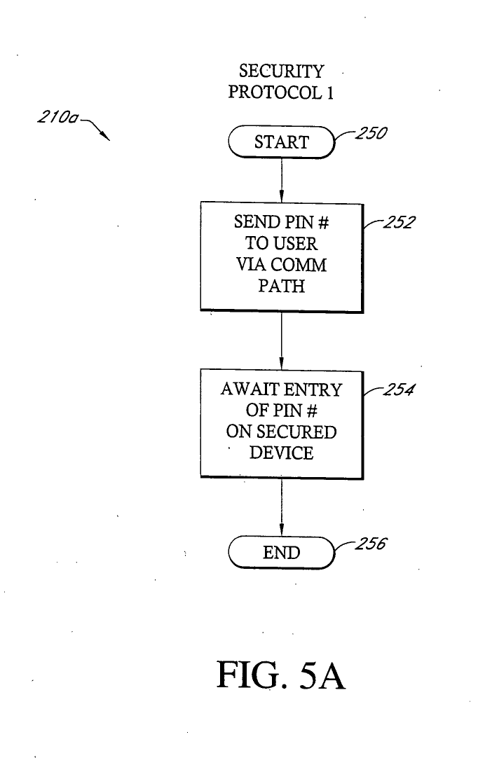

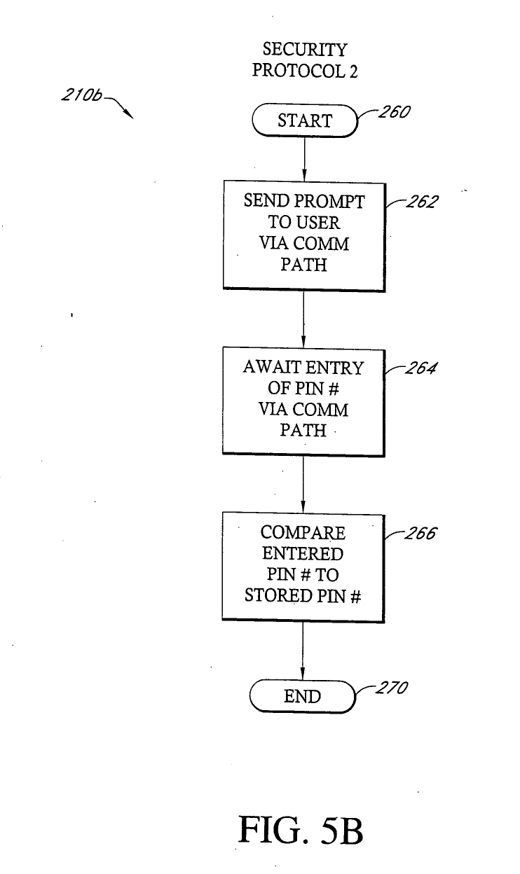

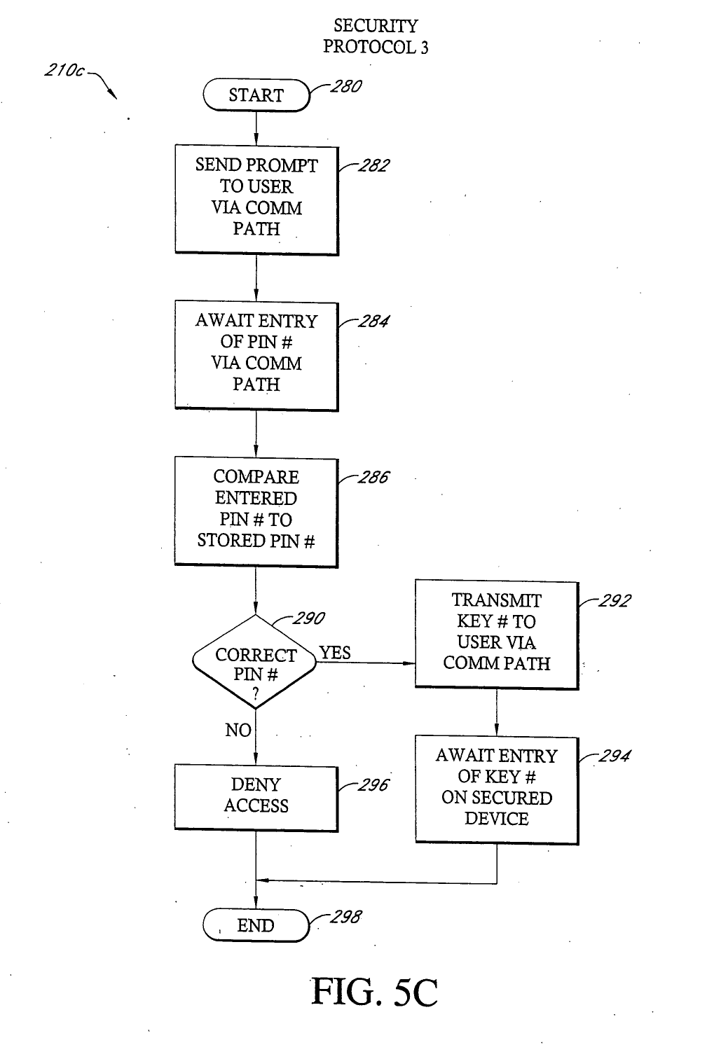

As discussed above, a plurality of different security protocols can be implemented in the identity authentication system depending upon the level of security that is required for a particular device, a particular individual or both. FIGS. 5A-5C illustrate three exemplary different security protocols that can be implemented by the system 100.

Referring initially to FIG. 5A, a first security protocol is illustrated. In this particular security protocol, the controller 110, retrieves the access authorization information in state 206 (FIG. 4) and ascertains by reviewing the individual attributes 130 and/or the device attributes 132 that the first security protocol is in order for this particular situation. Then the controller 110 implements this security protocol by sending a personal identification number or access code to the individual via the communication path that is stored in the individual security attributes 130 of the records 112. In one example, the controller 110 dials the cellular telephone of the individual via a modem which comprises the communications interface 116 and then transmits an alphanumeric message with the access code to be displayed to the individual. Subsequently, the individual then enters the access code into the input 104 of the secure component 102. The controller 110 then awaits, in state 254, the entry of the access code via the secure component 102. Once the access code has been received, the controller 110 then evaluates the access code entered on the input 104 of the secure component 102, in decision state 216, to ascertain that the access code is the same access code that was sent to the individual in state 252. This particular security protocol relies on the individual seeking access to the secure component having the communication device 120 in their possession and being in proximity to the secure component 102 to enter the access code via the input 104. It can, of course, be combined with the individual also having to input an additional password via the input 104 of the secure component 102 in question for enhanced security.

FIG. 5B is a flowchart that illustrates a second security protocol which represents a higher level of security than the security protocol of FIG. 5A. In this particular security protocol, once the controller 110 has received an access request and has retrieved the access authorization information, from a start state 260, the controller 110 sends a prompt signal to the individual's communication device via the communication path retrieved out of the individual security attribute 130 of the records 112. In one implementation, a prompt to enter an access code is sent via the communication interface 116 to a cellular telephone carried by the individual. The controller 110 then awaits, in state 264, the transmission of the access code from the cellular telephone via the communication interface 116. Subsequently, when the access code is received, it is compared, in state 266, to an access code that is stored as part of the ID criteria of the individual's security attributes 130 in the records 112.

This particular security protocol requires that the individual have their communication device 120 in their possession so as to be able to receive the prompt and also to be able to enter the access code and further requires that the individual know the access code. As a consequence, this particular security protocol requires two levels of security, i.e., what the person knows (Type I) and what the person has (Type II).

FIG. 5C is a flowchart of yet another potential security protocol 210 that can be implemented in the identity authentication process 200 of FIG. 4. In this particular security protocol, the controller 110, from a start state 280, sends a prompt to the individual via the communication path in state 282 in a manner similar to that described in connection with state 262 in FIG. 5B. The controller 110 then awaits the entry of an access code via the communication path, in state 284. The controller 110, upon receiving the access code from the individual's communication device 120, then compares it to the stored access code in state 286 and then determines whether it is the correct access code in decision state 290. If it is not the correct access code, the controller 110 then denies access to the secure component 102. Alternatively, if it is the correct access code, the controller 110 then develops a one-time key number, in a known manner, that is transmitted to the individual via the communication path in state 292. Hence, the individual receives on their communication device 120 a one-time key number which they can then subsequently enter into the input 104 of the secure component 102. The controller 110 then awaits the entry of the key number in state 294 on the input 104 of the secure component 102 and subsequently determines whether the key number is appropriately entered on the secure component.

This particular security protocol has an additional step of entering the one-time key number on the input 104 of the secure component 102 before access is allowed which provides a higher level of security. While one-time key numbers can be used to enhance security, any of a number of different codes can be sent to the individual's communication device 120 without departing from the spirit of the present invention.

From the foregoing, it will be appreciated that a number of different security protocols can be implemented depending upon the level of security that is desired for a particular individual or for a particular device. The three security protocols described above are simply exemplary of the possible different security protocols that can be implemented with the identity authentication system and process of the present invention.

As discussed previously in connection with FIG. 2, the fact that individuals already carry communication devices, such as cellular telephones, PDAs, and the like, which are in communication with the access controller 110, permits the individual to remotely instruct the controller 110 to have various secure components implement various instructions by sending signals to the controller with their communication device 120. One specific example of this is that an individual may call the controller 110 via the communication interface 116 and enter an appropriate code such that the controller 110 then enables a personal computer, which is one of the secure components 102 in a network, such that the personal computer can be turned on remotely by the individual.

FIG. 6 is an exemplary flow chart which generally illustrates the operation of the controller 110 as it implements a remote enablement request. As is illustrated in FIG. 6, the controller 110, from a start state 312, receives a remote enablement request from the user in state 314. Generally, this is accomplished by the individual dialing a pre-selected number which corresponds to the communication interface 116 and then entering an appropriate security code on a cellular telephone which is transmitted to the controller via the communications interface 116. Once the remote enablement request is received, in state 314, the controller 110 then retrieves, in state 316, the corresponding remote enablement information in state 316 from the individual's security attributes 130 of the records 112. The controller 110 then verifies, in decision state 318, whether the remote enablement code transmitted by the user is correct. This determination can be made by comparing the code entered and transmitted via the communications interface to a pre-stored record of the access code. If it is not correct, then the controller 110 denies remote enablement of the secure component in state 324. Alternatively, in this particular implementation, if the controller 110 determines that the access code is correct in decision state 318, the access controller 110 then remotely enables the device, in state 322. One specific example of a remotely enabled device, as discussed above, is turning on a personal computer. In many currently available computer networks, personal computers have a wake-on-LAN functionality such that a personal computer in a Local Area Network can be enabled by providing a wake-up signal from a central server or processor.

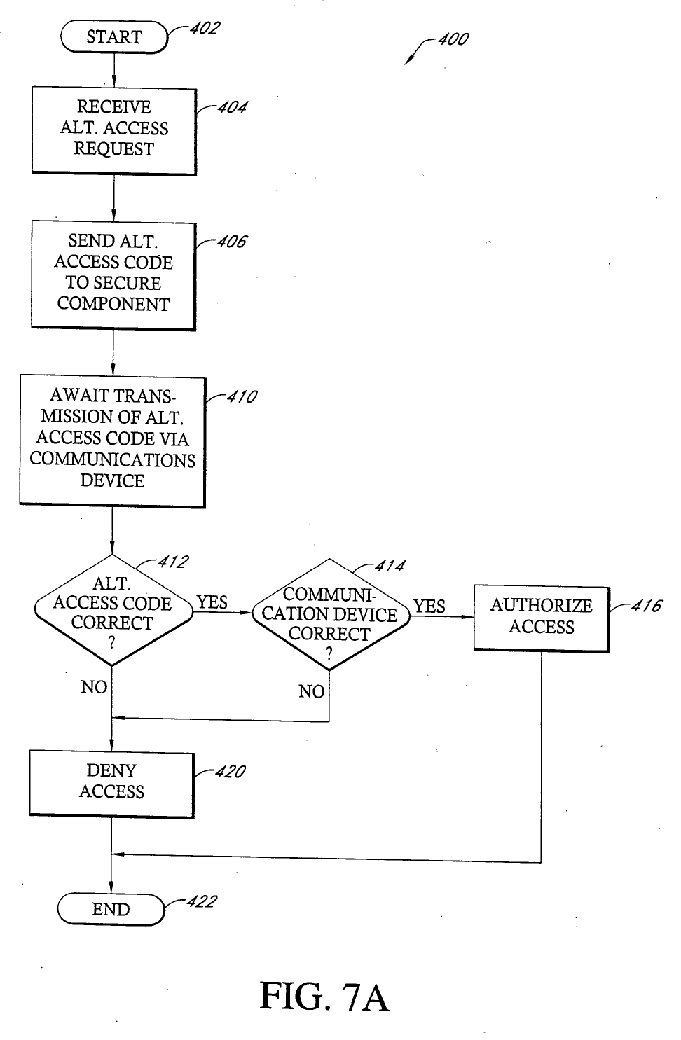

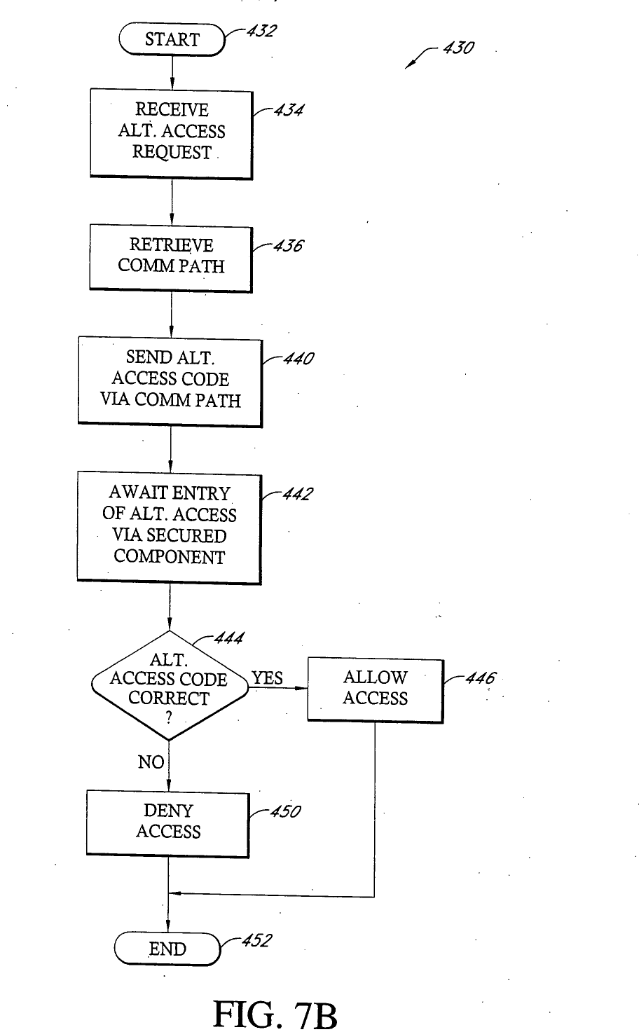

FIGS. 7A and 7B illustrate another unique aspect of the identity authentication system of the illustrated embodiment. As is generally understood, one common type of security protocol is a Type II security protocol wherein the individuals are assigned a uniquely coded physical item, such as a token, key card, etc. that must be inserted into an access device 103 (FIG. 2) to gain access to the secured component 102. The Type II authentication scheme may be used in conjunction with known password-type schemes or other types of security schemes in a manner known in the art. One difficulty that occurs with Type II security systems is that individuals often forget their token or key card. This results in a significant administrative burden for the administration of the system in that the administrators must then bypass the Type II security system. Bypassing the system usually requires the security person to go to the secured component 102 for which the user is seeking access and use a master access token or key to allow the individual access to the system. Alternatively, the system administrator must take the time to reprogram the security system to bypass the Type II authentication system.

Both of these approaches result in the degradation of the security of the system and further require system administrators to expend their time and resources reprogramming or reconfiguring the system to allow for access when the individual has forgotten their token or access device. To address this particular problem, the identification authentication system of the present invention makes use of the personal communications device 120 carried by the individual to allow an alternate path for access when the individual has forgotten their token or access card.

Referring specifically to FIG. 7A, a first scheme for allowing alternate access when an individual has forgotten their Type II personal access device is illustrated. In this embodiment, the access controller 110 from a start state 402 receives an alternate access request in state 404. The alternate access request can be provided to the access controller 110 in a number of different manners including, for example, providing an indication via the input 104 to the secured component 102 indicating that the individual does not have in their possession their personal access device or providing this information via their personal communication device 120.

In response to receiving an alternate access request by the user in state 404, the access controller 110, in one implementation, sends an alternate access code in state 406 to the secured component 102 via the device interface 106. In another implementation, the alternate access code is set to the individual's personal communication device 120 via the communications interface 116. The alternate access code can comprise a password, series of numbers, or the like that is then displayed or otherwise provided to the individual. Subsequently, the access controller 110 awaits the transmission of the alternate access code via the individual's communications device 120. In this particular implementation, the individual is provided with an alternate password via the secured component 102 which must then be transmitted back to the access controller 110 using the individual's personal communications device 120 via the communications interface 116.

The access controller 110 then determines in decision state 412 whether the alternate access code provided to the access controller 110 via the communications interface 116 is correct. If the alternate access code is not correct, then the access controller 110 sends a signal via the device interface 106 to the secured component 102 to deny access in state 420. Alternatively, if the access controller 110 determines in decision state 412 that the alternate access code is correct, the access controller 110 can then authorize access to the secured component 102 by sending an appropriate signal to the secured component 102 via the device interface 106.

However, as is illustrated in FIG. 7A, an additional level of security can be implemented wherein the access controller 110 verifies, in decision state 414, that the communication device 120 sending the alternate access code is the communications device 120 that has been registered as corresponding to the particular individual. As discussed above, the individual security attributes 130 may include the communications path which identifies the personal communications device that is registered to this particular individual. Hence, prior to allowing access in state 416, the access controller 110 can verify that not only did the individual successfully enter the alternate access code correctly, but that it was transmitted to the access controller 110 via the communications interface using a personal communications device 120 that is registered to this particular individual.

It will be appreciated that this particular implementation allows for individuals who have forgotten their Type II access device to still gain access to the system without significant administrative intervention. Moreover, requiring that the individual transmit the alternate access code using a communications device that is registered to the individual still provides a level of Type II security in that the individual seeking access must have in their possession a device, i.e., the communications device 120, that is registered for that individual.

FIG. 7B is an alternative implementation for allowing individuals who do not have in their possession their Type II access device an alternative path of access to the secured component 102. In this implementation, the access controller 110 from a start state 432 receives an alternate access request in state 434. The alternate access request can be provided in a number of ways including the individual sending the alternate access request via the input 104 of the secured component 102. Alternatively, it will be appreciated that the individual can also send an alternate access request to the access controller 110 using their personal communication device 120 via the communications interface 116 or in any of a number of different manners.

Upon receiving the alternate access request, the access controller 110 then retrieves the communications path for the individual from the individual security attributes 130 (FIG. 3A) in state 436. Subsequently, the access controller 110 then sends an alternate access code to the individual's personal communications device 120 in state 440 via the communications path retrieved in state 436. In one particular implementation, the access controller 110 automatically dials the cellular telephone belonging to the individual via the communications interface 116 and then provides an alphanumeric display of the access code.

The access controller 110, then awaits entry of the alternate access code via either the secured component 102 in state 442 or the personal communications device 120. In one implementation, the alternate access code is provided to the individual on their personal communications device 120 and the individual then must provide the alternate access code to the access controller 110 by using the input 104 of the secured component 102 which is then transmitted to the access controller via the device interface 106. In a second implementation, the alternate access code is provided to the individual via their personal communications device 120 and the individual must then provide the alternate access code to the access controller 110 via the communications interface by using the keypad of their personal communications device 120.

The access controller 110, then determines, in state 444, whether the alternate access code is correct. If the access code is correct, the access controller 110 then allows access in state 446 by sending an appropriate signal via the device interface 106 to the secured component 102 to allow access. Alternatively, if the alternate access code was input incorrectly, the access controller 110 then denies access in state 450 by sending an appropriate signal to the secured component 102 via the device interface 106.

FIGS. 7A and 7B illustrate two particular implementations where an identity authentication system that makes use of personal communications devices, such as cellular phones, PDAs and the like, can be used to permit selective access to secured components when the individual has forgotten their Type II security device. In both of these implementations, some degree of Type II security is maintained in that the individual must have in their possession their personal communications device in order to obtain access. Moreover, by preprogramming the system to allow for alternative access in this fashion, the administrative burden of allowing access to secured components for individuals who have forgotten their Type II security device is reduced.

It will be appreciated that both of the implementations illustrated in FIGS. 7A and 7B may be varied without departing from the spirit of the present invention. One particular aspect of the implementations of FIGS. 7A and 7B is that both of these implementations are alternatives to the preferred Type II secured system. As a consequence, the access controller 110 may also in both implementations make a record of the fact that the individual has sought the alternative access path and then may use this record for subsequent administrative follow-up. In many circumstances, it may be desirable to limit use of the alternative access path in order to maintain a higher level of Type II security.

The identity authentication system described herein thus provides a very flexible system for verifying the identity of individuals seeking access to secure components. The integration of individual personal communication devices into an access security system allows for greater security and further results in a more flexible system whereby additional security procedures can be implemented and additional functionality be enabled.

Although the above disclosed embodiments of the present invention have shown, described and pointed out the fundamental novel features of the invention as applied by the above disclosed embodiments, it should be understood that various omissions, substitutions and changes in the form of the detail of the devices, systems and/or methods illustrated may be made by those skilled in the art without departing from the scope of the present invention. Consequently, the scope of the invention should not be limited to the foregoing description, but should be defined by the appended claims.

1. A system for allowing an individual having a personal communications device an alternative access path to one or more secured components having an associated access device reader wherein the individual normally gains access to the system by at least in part positioning an access device into the access device reader, the system comprising:
at least one record that includes information about the individual, the information including information about the individual's personal communications device;
a controller having access to the at least one record wherein the controller is in communication with the one or more secured components and wherein the controller, in response to receiving a signal indicating that the individual seeking access to the one or more secured components does not have their access device, (i) retrieves information about the individual's personal communications device and (ii) sends an alternate access code to the individual and then subsequently evaluates whether the individual has provided the alternate access code back to the controller correctly to determine whether to permit access to the secured component; and
a communications interface that allows signals between the individual's communication device and the controller, wherein the controller uses the communications interface and the individual's personal communications device to allow the individual to receive or transmit the alternate access code to the controller.

2. The system of claim 1, wherein the controller sends the alternate access code to the individual via the secured component.

3. The system of claim 2, wherein the controller receives the alternate access code from the individual via the individual's personal communications device and the communications interface.

4. The system of claim 3, wherein the controller, prior to allowing access verifies that (i) the alternate access code has been transmitted correctly to the controller and (ii) the alternate access code is being transmitted from a personal communications device that is registered to the individual seeking access.

5. The system of claim 1, wherein the controller sends the alternate access code to the individual via the individual's personal communications device.

6. The system of claim 5, wherein the controller receives the alternate access code from the individual via the individual's personal communications device and the communications interface.

7. The system of claim 5, wherein the controller receives the alternate access code from the individual via the secured component.

8. The system of claim 1, wherein the at least one record includes the telephone number of the individual's cellular telephone.

9. A system for limiting access to at least one secured component having an associated access device reader to only authorized individuals, wherein the system permits access to the at least one secured component when an individual provides an access device to the access device reader that is recognized as an authorized access device wherein when the individual provides an indication to the system that the individual does not possess an authorized access device, the system communicates with a personal communications device registered to the individual such that the identity of the individual is verified through the use of the personal communications device.

10. The system of claim 9, wherein the system includes a record of personal communications devices belonging to authorized individuals.

11. The system of claim 10, wherein the record comprises telephone numbers for the individual's cellular telephone.

12. The system of claim 9, wherein the identity of the individual is verified by sending an access code to the individual's personal communications device and inducing the individual to transmit the access code back to the system.

13. The system of claim 12, wherein the at least one secured component has a user input through which the individual can input the access code provided to the individual's personal communications device.

14. The system of claim 9, wherein the system includes a display that displays an access code to the individual and a communications interface that communicates with the individual's personal communications device such that the individual transmits the access code provided via the display to the system via their personal communications device and the communications interface.

15. The system of claim 14, wherein the system, upon receipt of the access code verifies that the access code is being transmitted from the personal communications device registered to the individual and upon verification, then allows the individual access to the at least one secured component.

16. A method of allowing alternative access to a secured component wherein the secured component includes an access device reader and access to the access device is limited to individuals having an access device approved for accessing the secured component, the method comprising:
receiving a signal from an individual indicating that the individual does not have their access device for access to the secured component;
communicating with a personal communications device registered to the individual; and
verifying the individual's identity based upon the communications with the individual's personal communications device.

17. The method of claim 16, wherein receiving a signal from an individual comprises receiving a signal from a user interface associated with the secured component.

18. The method of claim 17, wherein verifying the individual's identity comprises:
sending an access code to the individual's personal communications device;
receiving a signal from the individual; and
evaluating the signal received from the individual to ascertain whether the signal includes the access code.

19. The method of claim 18, wherein receiving a signal from the individual comprises receiving a signal from the individual's personal communications device.

20. The method of claim 18, wherein receiving a signal from the individual comprises receiving a signal from a user interface that is associated with the secured component.

21. The method of claim 16, further comprising allowing access upon verification of the individual's identity.

22. The method of claim 21, wherein access is allowed when the individual transmits an appropriate access code and communication is established with the individual's personal communications device.
